(19) United States
(12) Patent Application Publication
(10) Pub. No.: US 2025/0033364 A1
(43) Pub. Date: Jan. 30, 2025

(54) LIQUID STORAGE CONTAINER AND LIQUID EJECTION APPARATUS

(71) Applicant: CANON KABUSHIKI KAISHA, Tokyo (JP)

(72) Inventors: KENJI TAMAMORI, Kanagawa (JP); TAKAYUKI KAMIMURA, Kanagawa (JP)

(21) Appl. No.: 18/771,524

(22) Filed: Jul. 12, 2024

(30) Foreign Application Priority Data
Jul. 26, 2023 (JP) 2023-121392
Apr. 17, 2024 (JP) 2024-066732

(51) Int. Cl. B41J 2/175

(52) U.S. Cl. CPC B41J 2/17523; B41J 2/17553

(57) ABSTRACT

A liquid storage container that includes: multiple liquid storage portions that store liquids; and multiple outlets through which the liquids are dispensed out of the multiple liquid storage portions, respectively, in which, on a first surface of the multiple liquid storage portions including a connection surface connected with the outlets of the liquid storage portions, A/B>1 is satisfied where an array pitch between midpoints of points where a center line, which is passing through centers of the adjacent outlets, intersects sections of the liquid storage portions is A, and an array pitch between the adjacent outlets is B.

### BACKGROUND OF THE INVENTION

### Field of the Invention

The present disclosure relates to a liquid storage container and a liquid ejection apparatus, and specifically relates to a liquid storage container including multiple liquid storage portions.

### Description of the Related Art

There is a liquid tank used in a liquid ejection apparatus such as an ink jet printing apparatus that can be refilled with a liquid. For example, use of a liquid storage container including an outlet to dispense the liquid makes it possible to refill the liquid tank with the liquid from the liquid storage container through the outlet. Japanese Patent Laid-Open No. 6-226991 (referred to as Literature 1) discloses a flexible ink container with a sealed structure that includes multiple ink storage portions, in which an ink container main body is formed by laminating flexible films of a low gas penetration ratio into multiple layers.

However, in Literature 1, on a surface including a connection surface connected with outlets of the liquid storage portions, there is a small difference between a distance between the substantial centers of the adjacent liquid storage portions and a distance between the outlets thereof. For this reason, in a case where the number of the liquid storage portions is increased, there is a concern that this increase causes an increase in the size or the number of members around the outlet and an increase in the amount of discarded members.

An object of the present disclosure is to provide a liquid storage container that can suppress an increase in the size of a member around an outlet of the liquid storage container and a liquid ejection apparatus using the liquid storage container.

### SUMMARY OF THE INVENTION

A liquid storage container according to an aspect of the present disclosure includes: multiple liquid storage portions that store liquids; and multiple outlets through which the liquids are dispensed out of the multiple liquid storage portions, respectively, in which, on a first surface of the multiple liquid storage portions including a connection surface connected with the outlets of the liquid storage portions, A/B>1 is satisfied where an array pitch between midpoints of points where a center line, which is passing through centers of the adjacent outlets, intersects sections of the liquid storage portions is A, and an array pitch between the adjacent outlets is B.

Further features of the present invention will become apparent from the following description of exemplary embodiments with reference to the attached drawings.

### BRIEF DESCRIPTION OF THE DRAWINGS

FIG. 1 is a perspective view of a liquid ejection apparatus;

FIG. 2 is a perspective view illustrating an internal configuration of a major portion of the liquid ejection apparatus;

FIG. 3 is a perspective view of a liquid tank of the liquid ejection apparatus;

FIGS. 4A to 4C are explanatory diagrams of a case of dispensing a liquid into the liquid tank from a liquid storage container;

FIGS. 5A and 5B are a side view and a top view of the liquid storage container according to a first embodiment;

FIGS. 6A and 6B are a side view and a top view of a modification 1 of the liquid storage container according to the first embodiment;

FIGS. 7A and 7B are a side view and a top view of a modification 2 of the liquid storage container according to the first embodiment;

FIGS. 8A and 8B are a side view and a top view of a modification 3 of the liquid storage container according to the first embodiment;

FIGS. 9A and 9B are a side view and a top view of a modification 4 of the liquid storage container according to the first embodiment; and

FIGS. 10A to 10E are top views of a liquid storage container according to a second embodiment.

### DESCRIPTION OF THE EMBODIMENTS

Embodiments are described below with reference to the drawings. Note that, the same configurations are described with the same reference numerals. Additionally, relative arrangement, shape, and the like of constituents described in the embodiments are merely examples.

### First Embodiment

### (Liquid Ejection Apparatus)

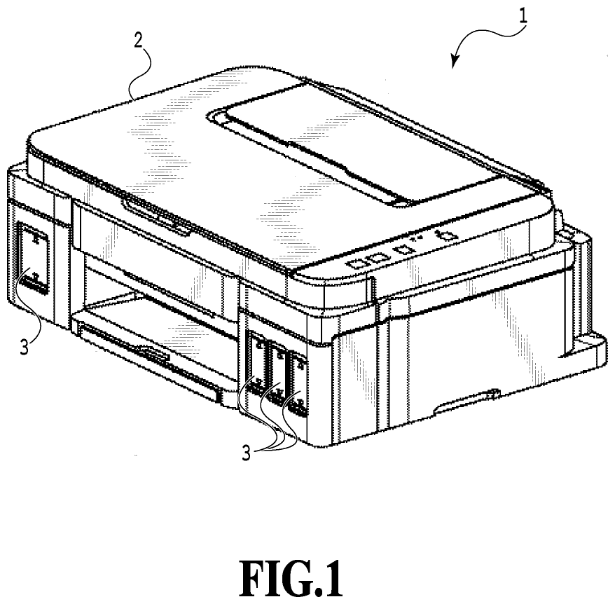

FIG. 1 is a perspective view of a liquid ejection apparatus 1 in which a liquid storage container in the present embodiment is used. The liquid ejection apparatus 1 is a serial type ink jet printing apparatus and includes a housing 2 and a liquid tank 3 arranged inside the housing 2. The liquid tank 3 stores an ink, which is a liquid to be ejected onto a printing medium (not illustrated).

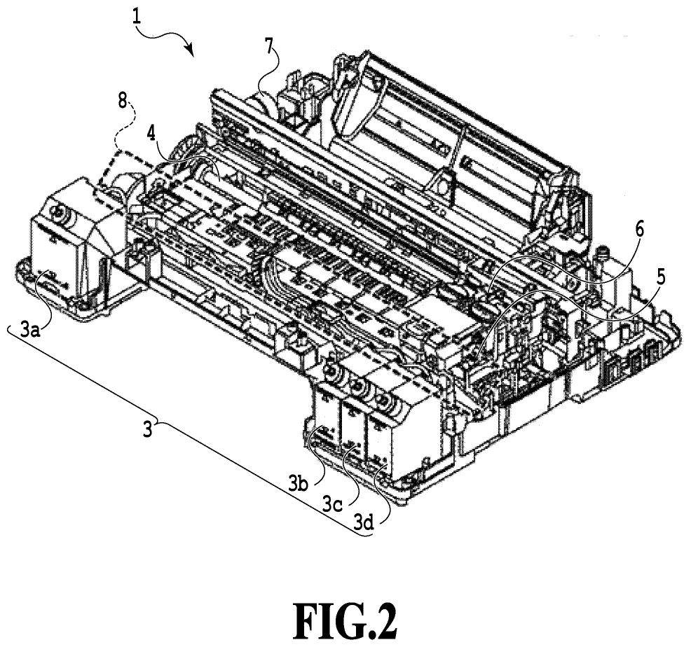

FIG. 2 is a perspective view illustrating an internal configuration of the liquid ejection apparatus 1 illustrated in FIG. 1. The liquid ejection apparatus 1 includes a conveyance roller 4 to convey the printing medium (not illustrated), a liquid ejection head 5 that ejects the liquid, a carriage 6 on which the liquid ejection head 5 is mounted, and a carriage motor 7 to drive the carriage 6. The liquid ejection apparatus 1 includes a liquid passage 8 arranged between the liquid tank 3 and the liquid ejection head 5. A type of the printing medium is not particularly limited as long as an image is formed thereon by the liquid ejected from the liquid ejection head 5. The type of the printing medium may be, for example, paper, cloth, an optical disc label surface, a plastic sheet, an OHP sheet, or the like.

The liquid is stored in the liquid tank 3, supplied to the liquid ejection head 5 via the liquid passage 8, and ejected from the liquid ejection head 5. As the liquid of the present embodiment, for example, four colors of inks (for example, cyan, magenta, yellow, and black) are used. Additionally, four liquid tanks 3a to 3d that store the corresponding colors of inks, respectively, are provided to the liquid tank 3. Hereinafter, in a case of identifying and mentioning the individual liquid tanks, an alphabet is provided at the end like the liquid tanks 3a to 3d, and in a case of mentioning an arbitrary liquid tank, it is referred to as the liquid tank 3. Each of the four liquid tanks 3a to 3d is arranged in a front surface portion of the liquid ejection apparatus 1 inside the housing 2.

### (Liquid Tank)

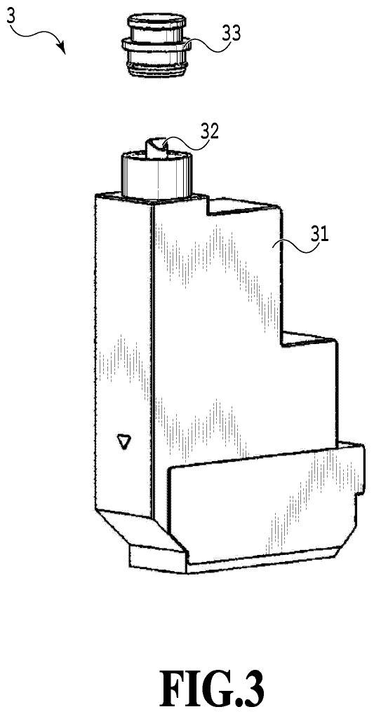

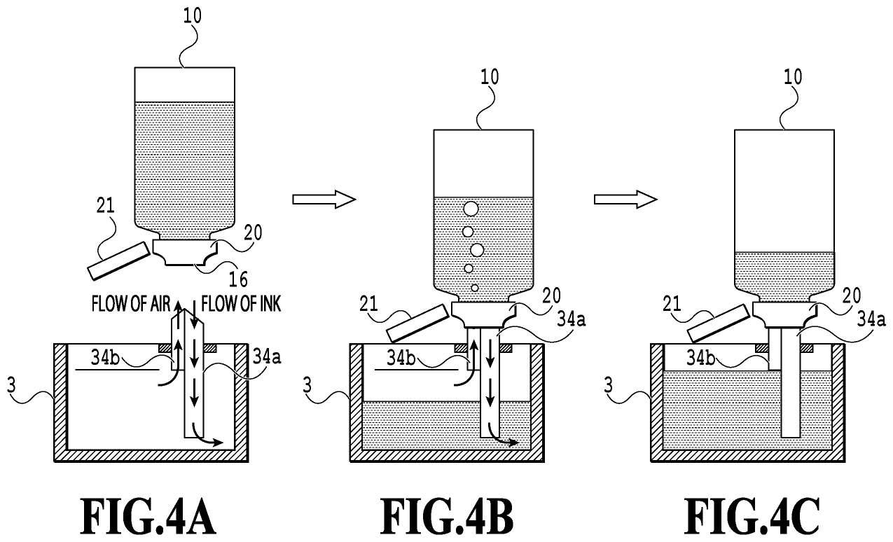

FIG. 3 is an exploded perspective view of the liquid tank 3 of the liquid ejection apparatus 1 illustrated in FIG. 1. The liquid tank 3 of the present embodiment includes a liquid tank main body 31 to store the liquid, an inlet 32 communicating with a liquid storage chamber in the liquid tank main body 31, and a tank lid 33 that can be mounted on the liquid tank main body 31 so as to cover the inlet 32. The liquid tank 3 includes a communication channel 34 extending in a vertical direction from the inlet 32 to the inside of the liquid tank main body 31. The communication channel 34 includes a liquid inlet path 34a (see FIG. 4A) to flow the liquid from a liquid storage container 10 described later into the liquid tank 3 and an air outlet path 34b (see FIG. 4A) to flow out the air in the liquid tank 3. The liquid inlet path 34a is arranged parallel to the air outlet path 34b in the liquid tank 3 and extends longer in the vertical direction than the air outlet path 34b does. A tip of the liquid inlet path 34a is arranged in a position near a bottom portion of the liquid tank 3. After refilling of the liquid tank 3 with the liquid, in order to suppress evaporation of the liquid from the liquid storage chamber in the liquid tank main body 31, the tank lid 33 is attached to the liquid tank main body 31 to seal the liquid storage chamber in the liquid tank main body 31.

(Refilling with Liquid by Gas-Liquid Exchange)

FIGS. 4A to 4C are explanatory diagrams of a case of dispensing the liquid into the liquid tank 3 from the liquid storage container 10 according to the present embodiment.

In the present embodiment, the liquid tank 3 is refilled with the liquid by gas-liquid exchange through the liquid storage container 10 from the inlet 32 exposed by detaching the tank lid 33 from the liquid tank main body 31. To be specific, as illustrated in FIG. 4A, the liquid tank 3 is in an empty state, and the liquid storage container 10 is in a state in which the liquid is stored therein. Then, refilling of the liquid tank 3 with the liquid is started by connecting an inlet and outlet port of the liquid storage container 10 to the inlet 32 of the liquid tank 3. Once refilling is started, as illustrated in FIG. 4B, the liquid in the liquid storage container 10 flows into the liquid tank 3 via the liquid inlet path 34a while the air in the liquid tank 3 flows out into the liquid storage container 10 via the air outlet path 34b, and the liquid tank 3 continues to be refilled with the liquid. As illustrated in FIG. 4C, once the liquid refilled in the liquid tank 3 reaches a tip of the air outlet path 34b, the tip of the air outlet path 34b in the liquid tank 3 is closed, and concurrently, the flow of the liquid into the liquid tank 3 from the liquid storage container 10 is stopped.

Thus, it is possible to refill the liquid tank 3 with the liquid by gas-liquid exchange. In the present embodiment, the liquid tank is refilled with the liquid by using the system of gas-liquid exchange; however, it is not limited thereto, and another system may be used.

### (Liquid Storage Container)

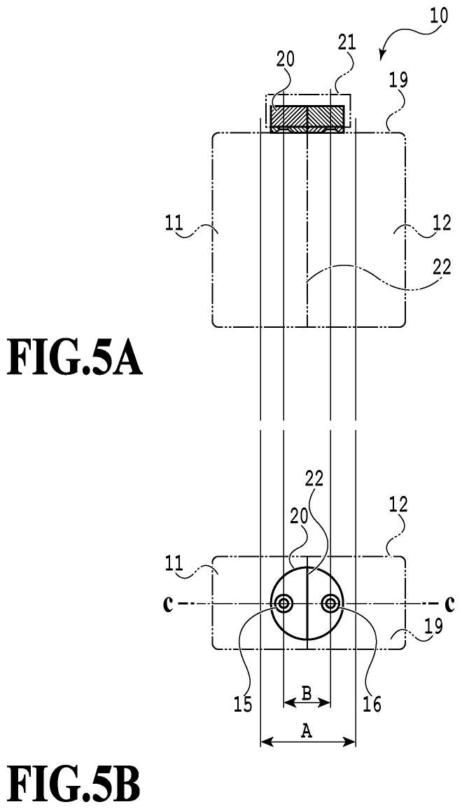

FIG. 5A is a side view of the liquid storage container 10 according to the present embodiment, and FIG. 5B is a top view of the liquid storage container 10. In the present embodiment, the liquid storage container 10 shows a configuration including two liquid storage portions. The liquid storage container 10 includes multiple liquid storage portions 11 and 12, an outlet portion 20, and a sealing portion 21 that seals the outlet portion 20. A partition wall 22 to form the liquid storage portions 11 and 12 by dividing the liquid storage container 10 into two is formed in the liquid storage container 10. Thus, it is possible to prevent mixing of liquids in the liquid storage container 10. The outlet portion 20 is positioned in a top portion of the liquid storage container 10 and formed in a circular shape. The outlet portion 20 includes outlets 15 and 16 through which the liquids are dispensed out of the multiple liquid storage portions 11 and 12, respectively. The outlets 15 and 16 are provided in the substantial center of the liquid storage container 10. The outlets 15 and 16 of the present embodiment are provided in the substantial center of the liquid storage container 10; however, it is not limited thereto, and the outlets 15 and 16 may be provided in an end portion. A first surface 19 including a connection surface connected with the outlets 15 and 16 of the liquid storage portions 11 and 12 is formed on the top portion of the liquid storage container 10, that is, top portions of the two liquid storage portions 11 and 12. On the first surface 19, it is preferable that A/B>1 is satisfied where A is an array pitch between midpoints of points where a center line C-C, which is passing through the centers of the adjacent outlets 15 and 16, intersects sections of the liquid storage portions 11 and 12, and B is an array pitch between the adjacent outlets 15 and 16.

Therefore, in the liquid storage container 10 according to the present embodiment, the outlets communicating with the multiple liquid storage portions 11 and 12 can be combined into one shape and downsized, and thus it is also possible to downsize the sealing portion that seals the outlets. Therefore, it is possible to reduce the number of the members used for the liquid storage container.

As material forming the liquid storage container 10, for example, PE (polyethylene), PP (polypropylene), or the like may be used, or other material may be used. Additionally, recycled plastic material may be used as the material forming the liquid storage container 10.

Note that, although the sealing portion 21 is formed in a lid shape in the present embodiment, it is not limited thereto, and the sealing portion 21 may be formed in a film shape. In a case of a film shape, it is possible to further reduce the number of the members used for the liquid storage container 10. Additionally, it is possible to refill the two liquid tanks with the liquids concurrently by making the array pitch B between the outlets 15 and 16 of the present embodiment and an array pitch between the multiple inlets 32 of the liquid tank 3 equal to each other.

### <Modification 1>

A modification 1 of the first embodiment of the present disclosure is described. Descriptions of a basic configuration of the present disclosure and a function and a configuration similar to that of the first embodiment are omitted, and different points are described.

The liquid ejection apparatus generally performs full color printing, and for example, the liquid tanks storing liquids of cyan, magenta, and yellow may be linearly arranged. In this case, the liquid storage container 10 in FIGS. 5A and 5B can store only two inks, and there is a possibility that refilling with three inks concurrently cannot be performed. Therefore, in the modification 1, a liquid storage container in which three liquid storage portions are formed for refilling with three inks concurrently is described.

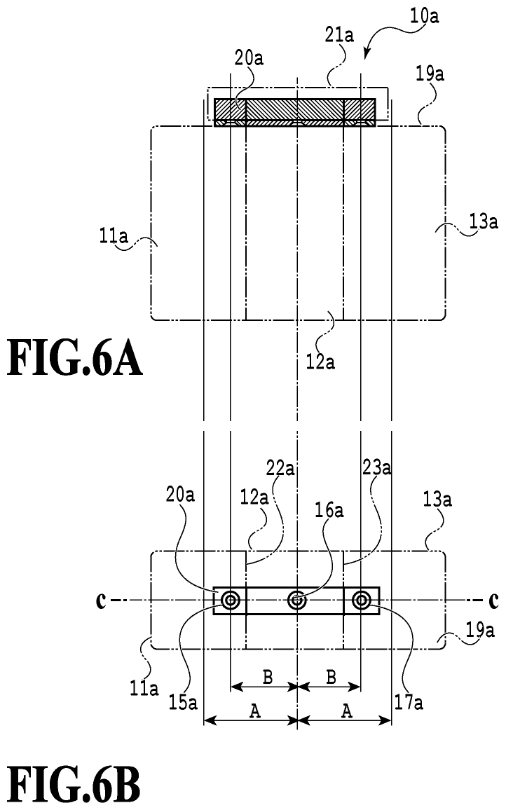

FIG. 6A is a side view of a liquid storage container 10a according to the present embodiment, and FIG. 6B is a top view of the liquid storage container 10a. In the modification 1, the liquid storage container 10a shows a configuration including three liquid storage portions. The liquid storage container 10a includes three liquid storage portions 11a, 12a, and 13a and a sealing portion 21a that seals an outlet portion 20a. Partition walls 22a and 23a to form the liquid storage portions 11a, 12a, and 13a by dividing the liquid storage container 10a into three are formed in the liquid storage container 10a. The outlet portion 20a is positioned in a top portion of the liquid storage container 10a and formed in a rectangular shape over the liquid storage portions 11a, 12a, and 13a. The outlet portion 20a includes outlets 15a, 16a, and 17a through which the liquids are dispensed out of the three liquid storage portions 11a, 12a, and 13a, respectively. The outlets 15a, 16a, and 17a are linearly provided in the substantial center of the liquid storage container 10a. A first surface 19a including a connection surface connected with the outlets 15a, 16a, and 17a of the liquid storage portions 11a, 12a, and 13a is formed on the top portion of the liquid storage container 10a, that is, top portions of the three liquid storage portions 11a, 12a, and 13a. On the first surface 19a, it is preferable that A/B>1 is satisfied where A is an array pitch between midpoints of points where a center line C-C of the adjacent three outlets 15a, 16a, and 17a intersects sections of the liquid storage portions 11a and 12a, and B is an array pitch between the adjacent outlets 15a and 16a. Meanwhile, on the first surface 19a, it is preferable that A/B>1 is satisfied where A is an array pitch between midpoints of points where the center line C-C of the adjacent three outlets 15a, 16a, and 17a intersects sections of the liquid storage portions 12a and 13a, and B is an array pitch between the adjacent outlets 16a and 17a.

Therefore, in the liquid storage container 10 according to the present embodiment, the outlets communicating with the multiple liquid storage portions 11a, 12a, and 13a can be combined into one shape and downsized, and thus it is also possible to downsize the sealing portion that seals the outlets. Therefore, it is possible to reduce the number of the members used for the liquid storage container.

### <Modification 2>

A modification 2 of the first embodiment of the present disclosure is described. Descriptions of a basic configuration of the present disclosure and a function and a configuration similar to that of the first embodiment are omitted, and different points are described.

In the liquid storage container of the modification 1, the liquid storage portions 11a, 12a, and 13a are linearly arranged. Incidentally, there is also a case where the liquid tanks are not linearly arranged but arranged in a circular form. Therefore, in the modification 2, a liquid storage container in which three liquid storage portions are formed in a circular form to correspond to the arrangement of the liquid tanks is described.

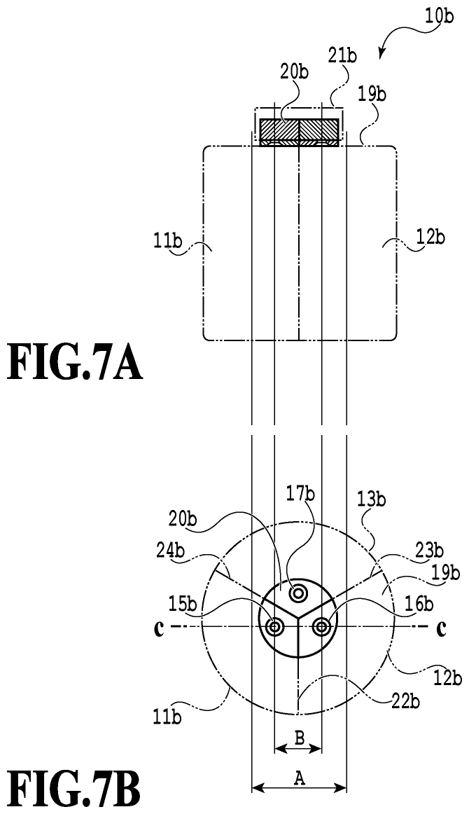

FIG. 7A is a side view of a liquid storage container 10b according to the present embodiment, and FIG. 7B is a top view of the liquid storage container 10b. In the modification 2, the liquid storage container 10b shows a configuration including three liquid storage portions in a circular form. The liquid storage container 10b includes three liquid storage portions 11b, 12b, and 13b and a sealing portion 21b that seals an outlet portion 20b. Partition walls 22b, 23b, and 24b to form the liquid storage portions 11b, 12b, and 13b by dividing the liquid storage container 10b into three in the form of a fan are formed in the liquid storage container 10b. The outlet portion 20b is positioned in a top portion of the liquid storage container 10b and formed in a circular shape over the liquid storage portions 11b, 12b, and 13b. The outlet portion 20b includes outlets 15b, 16b, and 17b through which the liquids are dispensed out of the three liquid storage portions 11b, 12b, and 13b, respectively. The outlets 15b, 16b, and 17b are provided in a circular form in the substantial center of the liquid storage container 10b. A first surface 19b including a connection surface connected with the outlets 15b, 16b, and 17b of the liquid storage portions 11b, 12b, and 13b is formed on the top portion of the liquid storage container 10b, that is, top portions of the three liquid storage portions 11b, 12b, and 13b. On the first surface 19b, it is preferable that A/B>1 is satisfied where A is an array pitch between midpoints of points where a center line of any two outlets of the adjacent three outlets 15b, 16b, and 17b intersects sections of the liquid storage portions of the two outlets, and B is an array pitch between the adjacent two outlets. To be specific, it is preferable that A/B>1 is satisfied where A is an array pitch between midpoints of points where a center line C-C of the adjacent two outlets 15b and 16b intersects sections of the liquid storage portions 11b and 12b, and B is an array pitch between the adjacent outlets 15b and 16b. Likewise, it is preferable that A/B>1 is satisfied where A is an array pitch between midpoints of points where a center line (not illustrated) of the adjacent two outlets 16b and 17b intersects sections of the liquid storage portions 12b and 13b, and B is an array pitch between the adjacent outlets 16b and 17b. Additionally, likewise, it is preferable that A/B>1 is satisfied where A is an array pitch between midpoints of points where a center line (not illustrated) of the adjacent two outlets 15b and 17b intersects sections of the liquid storage portions 11b and 13b, and B is an array pitch between the adjacent outlets 15b and 17b.

Therefore, in the liquid storage container 10b according to the present embodiment, the outlets communicating with the multiple liquid storage portions 11b, 12b, and 13b can be combined into one shape and downsized, and thus it is also possible to downsize the sealing portion that seals the outlets. Therefore, it is possible to reduce the number of the members used for the liquid storage container.

### <Modification 3>

A modification 3 of the first embodiment of the present disclosure is described. Descriptions of a basic configuration of the present disclosure and a function and a configuration similar to that of the first embodiment are omitted, and different points are described.

In the liquid storage container of the modification 1, the liquid storage portions 11a, 12a, and 13a are linearly arranged. Incidentally, there is also a case where the liquid tanks are not linearly arranged but arranged in a rectangular form. Therefore, in the modification 3, a liquid storage container in which three liquid storage portions are formed in a rectangular form to correspond to the arrangement of the liquid tanks is described.

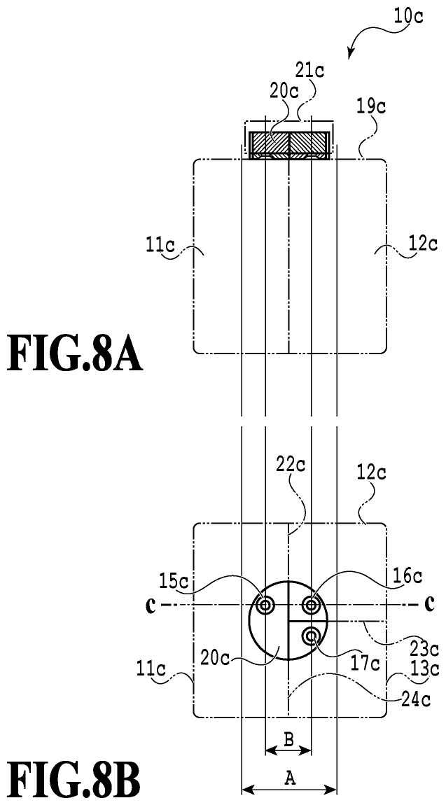

FIG. 8A is a side view of a liquid storage container 10c according to the present embodiment, and FIG. 8B is a top view of the liquid storage container 10c. In the modification 3, the liquid storage container 10c shows a configuration including three liquid storage portions in a rectangular form. The liquid storage container 10c includes three liquid storage portions 11c, 12c, and 13c and a sealing portion 21c that seals an outlet portion 20c. Partition walls 22c, 23c, and 24c to form the liquid storage portions 11c, 12c, and 13c by dividing the liquid storage container 10c into three in a rectangular form are formed in the liquid storage container 10c. The liquid storage portion 11c is formed to divide the liquid storage container 10c into two by the partition wall 22c and the partition wall 24c. Additionally, the liquid storage portion 12c and the liquid storage portion 13c are formed such that one of the divided liquid storage container 10c is divided into two by the partition wall 23c. The outlet portion 20c is positioned in a top portion of the liquid storage container 10c and formed in a circular shape over the liquid storage portions 11c, 12c, and 13c. The outlet portion 20c includes outlets 15c, 16c, and 17c through which the liquids are dispensed out of the three liquid storage portions 11c, 12c, and 13c, respectively. The outlets 15c, 16c, and 17c are provided in the substantial center of the liquid storage container 10c. A first surface 19c including a connection surface connected with the outlets 15c, 16c, and 17c of the liquid storage portions 11c, 12c, and 13c is formed on the top portion of the liquid storage container 10c, that is, top portions of the three liquid storage portions 11c, 12c, and 13c. On the first surface 19c, it is preferable that A/B>1 is satisfied where A is an array pitch between midpoints of points where a center line C-C of the adjacent two outlets 15c and 16c intersects sections of the liquid storage portions 11c and 12c, and B is an array pitch between the adjacent outlets 15c and 16c.

Thus, with the liquid of a great consumption amount being stored in a liquid storage portion having a great capacity, it is possible to perform refilling with the liquids including the liquid of a great consumption amount all at once.

### <Modification 4>

A modification 4 of the first embodiment of the present disclosure is described. Descriptions of a basic configuration of the present disclosure and a function and a configuration similar to that of the first embodiment are omitted, and different points are described.

In the liquid ejection apparatus that performs general full color printing, for example, the liquid tanks storing the liquids of cyan, magenta, yellow, and black may be arranged close to each other. In the modification 4, a liquid storage container in which four liquid storage portions are formed to refill the liquid tanks with the four inks is described.

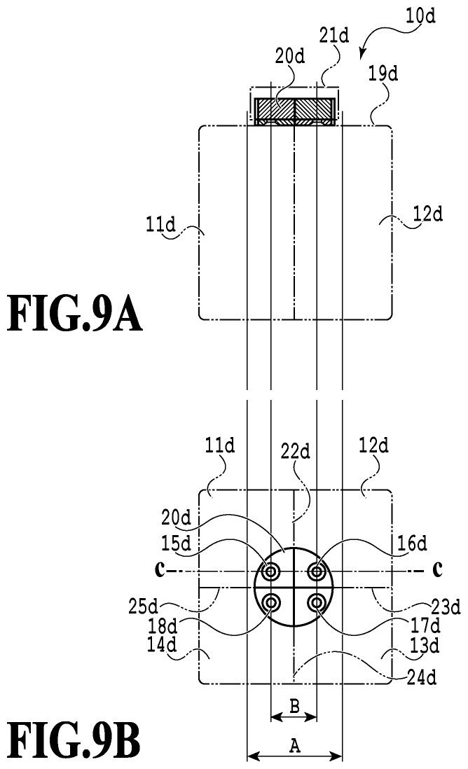

FIG. 9A is a side view of a liquid storage container 10d according to the present embodiment, and FIG. 9B is a top view of the liquid storage container 10d. In the modification 4, the liquid storage container 10d shows a configuration including four liquid storage portions in a rectangular form. The liquid storage container 10d includes four liquid storage portions 11d, 12d, 13d, and 14d and a sealing portion 21d that seals an outlet portion 20d. Partition walls 22d, 23d, 24d, and 25d to form the liquid storage portions 11d, 12d, 13d, and 14d by dividing the liquid storage container 10d into four in a rectangular form are formed in the liquid storage container 10d. The liquid storage portion 11d is formed by the partition wall 22d and the partition wall 25d. Additionally, the liquid storage portion 12d is formed by the partition wall 22d and the partition wall 23d. Moreover, the liquid storage portion 13d is formed by the partition wall 23d and the partition wall 24d. Furthermore, the liquid storage portion 14d is formed by the partition wall 24d and the partition wall 25d. The outlet portion 20d is positioned in a top portion of the liquid storage container 10d and formed in a circular shape over the liquid storage portions 11d, 12d, 13d, and 14d. The outlet portion 20d includes outlets 15d, 16d, 17d, and 18d through which the liquids are dispensed out of the four liquid storage portions 11d, 12d, 13d, and 14d, respectively. The outlets 15d, 16d, 17d, and 18d are provided in the substantial center of the liquid storage container 10d. A first surface 19d including a connection surface connected with the outlets 15d, 16d, 17d, and 18d of the liquid storage portions 11d, 12d, 13d, and 14d is formed on the top portion of the liquid storage container 10d, that is, top portions of the four liquid storage portions 11d, 12d, 13d, and 14d. On the first surface 19d, it is preferable that A/B>1 is satisfied where A is an array pitch between midpoints of points where a center line C-C of the adjacent two outlets 15d and 16d intersects sections of the liquid storage portions 11d and 12d, and B is an array pitch between the adjacent outlets 15d and 16d.

With the liquid storage container according to the present disclosure, it is possible to dispense the multiple liquids all at once by the multiple liquid storage portions and the outlets communicating with the multiple liquid storage portions. Therefore, it is possible to enhance the convenience in ink refilling by a user. In this case, because of the above-described gas-liquid exchange, refilling can be automatically stopped once the liquid storage portions are full even in a case of dispensing all at once. Therefore, it is possible to dispense a required amount of liquid with no concern of liquid overflow.

As above, the liquid storage container according to the present disclosure includes multiple liquid storage portions that store liquids and multiple liquid outlets through which the liquids are dispensed out of the multiple liquid storage portions, respectively. On a first surface of the multiple liquid storage portions including a connection surface connected with the liquid outlets of the liquid storage portions, an array pitch between midpoints of points where a center line, which is passing through the adjacent liquid outlet centers, intersects sections of the liquid storage portions is A, and an array pitch between the adjacent liquid outlets is B. A relationship between the array pitch A and the array pitch B satisfies A/B>1. Therefore, it is possible to provide a liquid storage container that can reduce the number of members used for the liquid storage container by sharing and downsizing constituent members of the liquid storage container.

### Second Embodiment

A second embodiment according to the present disclosure is described. Note that, description of a portion duplicated from the first embodiment is omitted.

The first surface 19 including the connection surface connected with the liquid outlets of the liquid storage portions is formed on the liquid storage container 10 according to the second embodiment. In the liquid storage container 10, on the first surface 19, the array pitch between the midpoints of the points where the center line C-C, which is passing through the centers of the adjacent liquid outlets 15 and 16, intersects the sections of the liquid storage portions is A, and the array pitch between the adjacent liquid outlets is B. In this case, A/B>1, and also A/B<2. It is preferable that a ratio between the array pitch A and the array pitch B is A/B<2 since it is a range that prevents oversize of the liquid storage portion. Additionally, since it is a range that prevents the outlets from being excessively close to each other, it is preferable because it is possible to suppress mixing of the inks between the adjacent outlets. Note that, since the liquid storage container 10 is molded similarly to that in the embodiment 1, it is possible to suppress liquid overflow in dispensing the liquid as with the embodiment 1.

It is preferable that there is a partition wall between the outlets because it is possible to suppress mixing of the liquids between the outlets. In addition, it is more preferable that the partition wall is higher than a height of each outlet.

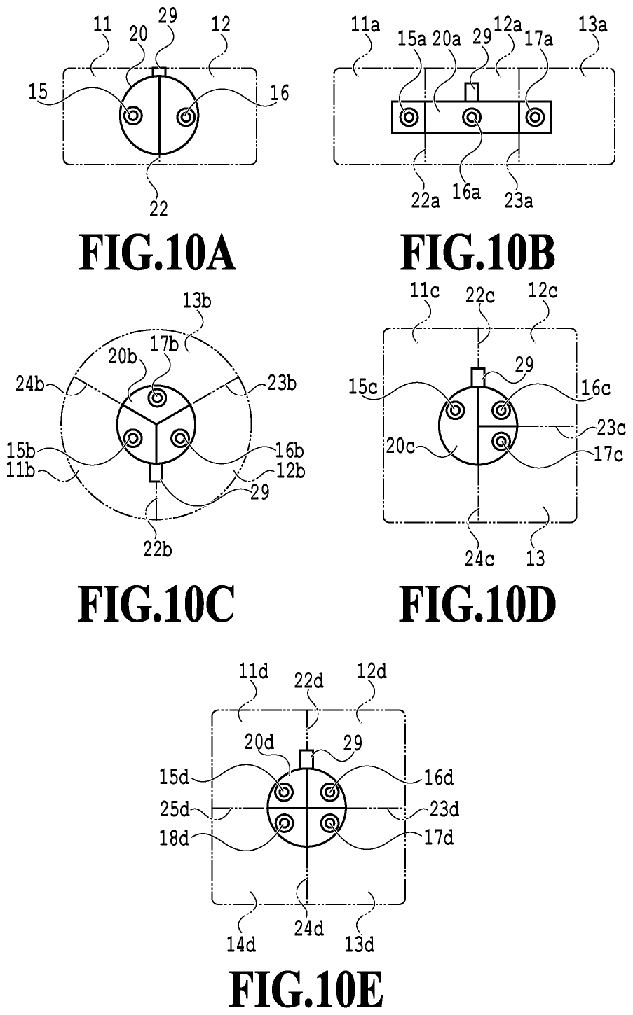

As illustrated in FIGS. 10A to 10E, a member 29 that defines how the outlets are arrayed may be arranged in each of the combined outlet portions 20, 20a, 20b, 20c, and 20d. It is possible to suppress refilling of the liquid tank with a wrong liquid while the liquid refilling by attaching the liquid storage container 10 in a direction in which the member 29 that defines how the outlets are arrayed is fitted to a member (not illustrated) that defines how the liquid tanks 3 are arrayed. Note that, although a shape of the member 29 that defines how the outlets are arrayed is illustrated in rectangular as an example in the second embodiment, another shape may be applied. According to the present embodiment, in the liquid storage container including the multiple liquid storage portions, since the minimum number of the member 29 that defines how the outlets are arrayed is one, it is possible to reduce the number of the members for the liquid storage container.

As described above, according to the present disclosure, it is possible to suppress liquid overflow while the liquid refilling in a liquid storage container that allows a printer to be refilled with multiple liquids all at once. Additionally, it is possible to suppress refilling of a liquid tank with a wrong liquid while the liquid refilling. Moreover, it is possible to provide a liquid storage container that can reduce the number of members used for the liquid storage container by sharing and downsizing constituent members of the liquid storage container. That is, it is possible to decrease the amount of discarded members. Since the member of the liquid storage container contains plastic, the decrease of the discarded members is that, in other words, it is possible to decrease the amount of discarded plastic. Therefore, the technologies described in this specification have the potential to contribute to the achievement of a sustainable society, such as a decarbonized society/circular society.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2023-121392 filed Jul. 26, 2023, and No. 2024-066732 filed Apr. 17, 2024, which are hereby incorporated by reference wherein in their entirety.

What is claimed is:

1. A liquid storage container, comprising:
a plurality of liquid storage portions that store liquids; and
a plurality of outlets through which the liquids are dispensed out of the plurality of liquid storage portions, respectively, wherein
on a first surface of the plurality of liquid storage portions including a connection surface connected with the outlets of the liquid storage portions, A/B>1 is satisfied where an array pitch between midpoints of points where a center line, which is passing through centers of adjacent outlets, intersects sections of the liquid storage portions is A, and an array pitch between the adjacent outlets is B.

2. The liquid storage container according to claim 1, wherein
A/B<2 is satisfied with a relationship of the array pitch A and the array pitch B.

3. The liquid storage container according to claim 1, wherein
the plurality of liquid storage portions are in a rectangular form.

4. The liquid storage container according to claim 1, wherein
the plurality of liquid storage portions are in the form of a fan.

5. The liquid storage container according to claim 1, wherein
a partition wall is formed between the plurality of outlets, and the partition wall is higher than a height of the plurality of outlets.

6. The liquid storage container according to claim 1, further comprising:
a member that defines how the plurality of outlets are arranged.

7. A liquid ejection apparatus, comprising:
the liquid storage container according to claim 1;
a plurality of liquid tanks that store the liquids; and
a liquid ejection head that is connected to the plurality of liquid tanks and ejects the liquids, wherein
in a case of refilling the plurality of liquid tanks, the liquid storage container refills the liquid tanks with a plurality of liquids by gas-liquid exchange.
